(19) United States
(12) Patent Application Publication
(10) Pub. No.: US 2026/0368245 A1
(43) Pub. Date: Nov. 19, 2026

(54) On Device Attribution

(71) Applicant: Google LLC, Mountain View, CA (US)

(72) Inventors: Satvik Chauhan, Mountain View, CA (US); Haonan Chen, Mountain View, CA (US); Kevin Wei Li yeo, New York, NY (US); Da Won Lee, Jersey City, NJ (US); Leili Rasouli, Los Altos, CA (US); Zhern Sue Lai, New York, NY (US)

(21) Appl. No.: 18/880,594

(22) PCT Filed: Oct. 15, 2024
(86) PCT No.: PCT/US2024/051402

§ 371 Date: Jan. 2, 2025

(51) Int. Cl. G06F 16/48; G06F 16/435

(52) U.S. Cl. CPC G06F 16/489; G06F 16/435

(57) ABSTRACT

The technology is generally directed to enabling on-device attribution using network identifier-derived transient identifiers. The network identifiers may be, for example, internet protocol addresses associated with a user device. The attribution may be determined based on a user engagement with digital content and subsequent installation of an application associated with the digital content. For example, transient identifiers, such as hashes, may be generated in response to user engagement and the application installation. At least some of the hashes may be encrypted, or keyed. The hashes are transient identifiers that remove any personalized information associated with the user such that the user remains anonymous while an attribution can still be determined. The hashes generated in response to the user engagement and application installation may be compared to determine a match. A match may be considered an attribution after being validated.

### BACKGROUND

Content providers and content creators typically measure content performance deterministically, using identifiers associated with users or their devices. The content performance can be used to train content serving models, such that the models can identify relevant content to be provided for output to the given user or user device.

Systems have substantially eliminated device identifiers, thereby disrupting content suppliers as the content suppliers and/or content creators can no longer measure content campaign performance deterministically. Without the attribution data for a given user or user device, the content serving models deteriorate, such that the content identified by the models is less relevant to the user or user device. Less relevant content leads to a less desirable user experience, poor content campaign performance, and decreased computational efficiency by having to identify and provide alternative, potentially more relevant, content to replace the irrelevant content.

### BRIEF SUMMARY

The technology is generally directed to enabling attributions to be determined on a user-device based on network identifier-derived transient identifiers. The on-device attribution may be determined based on a comparison of transient identifiers generated in response to a user engagement with digital content and transient identifiers generated in response to an installation of an application. The use of transient identifiers derived from network identifiers, such as a network, e.g., an internet protocol address, ensures that the identity of a user associated with the device is anonymous, e.g., unidentifiable. Further, the use of transient identifiers protects against external attempts to access information without authorization. However, the use of transient identifiers still provides the systems described herein to successfully identify attributions to user engagement with digital content, thereby allowing the publishers and/or content creators associated with the digital content to leverage attribution data when generating digital content campaigns.

One aspect of the disclosure is directed to a method for determining an application was installed in response to user engagement with digital content, the method comprising: installing, by one or more processors of a user device, the application on the user device; generating, by the one or more processors of the user device, an installation keyed hash of a network identifier associated with the user device; transmitting, by the one or more processors of the user device, to a server, a query including at least a portion of the installation keyed hash; receiving, by the one of more processors of the user device in response to the query, a plurality of candidate matches; decrypting, by the one or more processors of the user device, at least a portion of the plurality of candidate matches, wherein the plurality of candidate matches comprise at least a portion of timestamped engagement hashes; comparing, by the one or more processors of the user device, at least the portion of the timestamped engagement hashes to at least one of a timestamped installation hash or the installation keyed hash; when at least a portion of at least one of the timestamped engagement hashes matches at least a portion of the timestamped installation hash, identifying, by the one or more processors of the user device, the timestamped installation hash as at least one possible valid match; and transmitting, by the one or more processors of the user device to the server, the at least one possible valid match for validation.

The installation keyed hash, the timestamped engagement hashes, and the timestamped installation hash may be generated using the same hash function. The installation keyed hash and at least one of the timestamped engagement hashes may be generated using a same network identifier. The method may further comprise transmitting, by the one or more processors of the user device to the server, an indication of the user engagement with the digital content.

The method may further comprise generating, by one or more processors of the server, a database of user engagements, the generating comprising: generating, by the one or more processors of the server, an engagement keyed hash of a network identifier associated with the indication of the user engagement, wherein the network identifier associated with the indication of user engagement corresponds to the network identifier associated with the user device; generating, by the one or more processors of the server, the timestamped engagement hash, wherein the timestamped engagement hash comprises a hash of the engagement keyed hash and a timestamp associated with the indication of the user engagement; and storing, by the one or more processors of the server in communication with memory, the engagement keyed hash and the timestamped engagement hash. The timestamp associated with the indication of the user engagement may include at least one of a date, a time, or a window of time of the user engagement.

The method may further comprise generating, by the one or more processors of the user device, a timestamped installation hash, wherein the timestamped installation hash comprises a hash of the installation keyed hash and a timestamp associated with the application installation. The timestamp associated with the application installation may include at least one of a date, a time, or a window of time of the application installation. The method may further comprise encrypting, by the one or more processors of the user device, the timestamped installation hash using a device side generated key; and transmitting, by the one or more processors of the user device to the server as part of the query, the encrypted timestamped installation hash. The method may further comprise encrypting, by the one or more processors of the server, the timestamped installation hash with a server side key such that the timestamped installation hash is doubly encrypted; and receiving, by the one or more processors of the user device, the encrypted timestamped installation hash as part of the plurality of candidate matches. The method may further comprise decrypting, by the one or more processors of the user device, the encrypted timestamped installation hash to generate a redacted timestamped installation hash; and the comparing further comprising comparing, by the one or more processors of the user device, the redacted timestamped installation hash to at least a portion of the timestamped engagement hash.

The method may further comprise filtering, by the one or more processors of the server, the plurality of candidate matches based on a window of time; and wherein the window of time is determined based on a timestamp associated with the indication that the application has been installed or a timestamp associated with a user engagement with the digital content.

The plurality of candidate matches may comprise a portion of a timestamped engagement hash corresponding to the portion of the installation keyed hash.

The method may further comprise validating, by the one or more processors of the server, the at least one possible valid match as a valid match, wherein a valid match indicates that the application was installed in response to the user engagement with the digital content. The method may further comprise decrypting, by the one or more processors of the server, the at least one possible valid match, and wherein when the at least one possible valid match is successfully decrypted, identifying the at least one possible valid match as an attribution that the application was installed in response to the user engagement with the digital content.

The query may further comprise the timestamped installation hash, and the plurality of candidate matches may further comprise at least one of an encryption of the timestamped installation hash or an encryption of attribution and deidentification parameters.

Another aspect of the disclosure is directed to a system comprising one or more processors; and one or more storage devices coupled to the one or more processors and storing instructions that, when executed by the one or more processors, cause the one or more processors to perform operations comprising: installing the application on the user device; generating an installation keyed hash of a network identifier associated with the user device; transmitting to a server, a query including at least a portion of the installation keyed hash; receiving, in response to the query, a plurality of candidate matches; decrypting at least a portion of the plurality of candidate matches, wherein the plurality of candidate matches comprise at least a portion of timestamped engagement hashes; comparing at least the portion of the timestamped engagement hashes to at least one of a timestamped installation hash or the installation keyed hash; when at least a portion of at least one of the timestamped engagement hashes matches at least a portion of the timestamped installation hash, identifying the timestamped installation hash as at least one possible valid match; and transmitting, to the server, the at least one possible valid match for validation.

Yet another aspect of the disclosure is directed to one or more non-transitory computer-readable media for storing instructions that, when executed by one or more processors, cause the one or more processors to perform operations comprising the method of: installing the application on the user device; generating an installation keyed hash of a network identifier associated with the user device; transmitting to a server, a query including at least a portion of the installation keyed hash; receiving, in response to the query, a plurality of candidate matches; decrypting at least a portion of the plurality of candidate matches, wherein the plurality of candidate matches comprise at least a portion of timestamped engagement hashes; comparing at least the portion of the timestamped engagement hashes to at least one of a timestamped installation hash or the installation keyed hash; when at least a portion of at least one of the timestamped engagement hashes matches at least a portion of the timestamped installation hash, identifying the timestamped installation hash as at least one possible valid match; and transmitting, to the server, the at least one possible valid match for validation.

Another aspect of the disclosure is directed to one or more computer program products including instructions that, when executed by one or more processors, cause the one or more processors to perform operations comprising the method of installing the application on the user device; generating an installation keyed hash of a network identifier associated with the user device; transmitting to a server, a query including at least a portion of the installation keyed hash; receiving, in response to the query, a plurality of candidate matches; decrypting at least a portion of the plurality of candidate matches, wherein the plurality of candidate matches comprise at least a portion of timestamped engagement hashes; comparing at least the portion of the timestamped engagement hashes to at least one of a timestamped installation hash or the installation keyed hash; when at least a portion of at least one of the timestamped engagement hashes matches at least a portion of the timestamped installation hash, identifying the timestamped installation hash as at least one possible valid match; and transmitting, to the server, the at least one possible valid match for validation.

Another aspect of the disclosure is directed to a system for determining an application was installed in response to user engagement with digital content, the system comprising: a user device comprising one or more processors, the one or more processors of the user device configured to: generate an installation keyed hash of a network identifier associated with the user device; and transmit, to a server, a query including at least a portion of the installation keyed hash. The system further comprises the server comprising one or more processors, the one or more processors of the server configured to: identify, in response to the query, a plurality of candidate matches; and transmit, to the user device, the plurality of candidate matches, wherein the plurality of candidate matches comprise at least timestamped engagement hashes. The one or more processors of the user device are further configured to: receive the plurality of candidate matches; decrypt at least a portion of the plurality of candidate matches; compare at least the portion of the timestamped engagement hashes to at least one of the timestamped installation hash and the installation keyed hash; when at least a portion of at least one of the timestamped engagement hashes matches at least a portion of the timestamped installation hash, identifying the timestamped installation hatch as at least one possible valid match; and transmit, to the server, the at least one possible valid match for validation.

The installation keyed hash, the timestamped engagement hashes, and the timestamped installation hash may be generated using the same hash function. The installation keyed hash and at least one of the timestamped engagement hashes may be generated using a same network identifier.

The one or more processors of the user device may be further configured to transmit, to the server, an indication of the user engagement with the digital content.

The one or more processors of the server may be further configured to: generate a database of user engagements, the generating comprising: generate an engagement keyed hash of a network identifier associated with the indication of a given user engagement, wherein the network identifier associated with the indication of user engagement corresponds to the network identifier associated with the user device; generate the timestamped engagement hash, wherein the timestamped engagement hash comprises a hash of the engagement keyed hash and a timestamp associated with the indication of the user engagement; and store the engagement keyed hash and the timestamped engagement hash. The one or more processors of the server may be further configured to query the database of user engagements in response to receiving the query from the user device. The timestamp associated with the indication of the user engagement may include at least one of a date, a time, or a window of time of the user engagement.

The one or more processors of the user device may be further configured to generate a timestamped installation hash, wherein the timestamped installation hash comprises a hash of the installation keyed hash and a timestamp associated with the application installation. The timestamp associated with the application installation may include at least one of a date, a time, or a window of time of the application installation. The one or more processors of the user device are further configured to: encrypt the timestamped installation hash using a device side generated key; and transmit, to the server, the encrypted timestamped installation hash as part of the query. The one or more processors of the server are further configured to: encrypt the timestamped installation hash with a server side key such that the timestamped installation hash is doubly encrypted; and transmit, to the user device, the encrypted timestamped installation hash as part of the plurality of candidate matches. The one or more processors of the user device are further configured to: decrypt the encrypted timestamped installation hash to generate a redacted timestamped installation hash; and the comparing further comprising comparing the redacted timestamped installation hash to at least a portion of the timestamped engagement hash.

The one or more processors of the server may be further configured to: filter the plurality of candidate matches based on a window of time; and wherein the window of time is determined based on a timestamp associated with the indication that the application has been installed or a timestamp associated with a user engagement with the digital content.

The plurality of candidate matches may comprise a portion of an timestamped engagement hash corresponding to the portion of the installation keyed hash.

The one or more processors of the server may be further configured to validate the at least one possible valid match as a valid match, wherein a valid match indicates that the application was installed in response to the user engagement with the digital content.

The one or more processors of the server may be further configured to decrypt the at least one possible valid match; and when the at least one possible valid match is successfully decrypted, identifying the at least one possible valid match as an attribution that the application was installed in response to the user engagement with the digital content.

The query may further comprise the timestamped installation hash, and the plurality of candidate matches may further comprise at least one of an encryption of the timestamped installation hash or an encryption of attribution and deidentification parameters.

Yet another aspect of the disclosure is directed to one or more non-transitory computer-readable media for storing instructions that, when executed by one or more processors, cause the one or more processors to perform operations comprising the method of generating an installation keyed hash of a network identifier associated with the user device; transmitting, to a server, a query including at least a portion of the installation keyed hash; identifying, in response to the query, a plurality of candidate matches; transmitting, to the user device, the plurality of candidate matches, wherein the plurality of candidate matches comprise at least timestamped engagement hashes; receiving the plurality of candidate matches; decrypting at least a portion of the plurality of candidate matches; comparing at least the portion of the timestamped engagement hashes to at least one of the timestamped installation hash and the installation keyed hash; when at least a portion of at least one of the timestamped engagement hashes matches at least a portion of the timestamped installation hash, identifying the timestamped installation hatch as at least one possible valid match; and transmitting, to the server, the at least one possible valid match for validation.

Another aspect of the disclosure is directed to one or more computer program products including instructions that, when executed by one or more processors, cause the one or more processors to perform operations comprising the method of generating an installation keyed hash of a network identifier associated with the user device; transmitting, to a server, a query including at least a portion of the installation keyed hash; identifying, in response to the query, a plurality of candidate matches; transmitting, to the user device, the plurality of candidate matches, wherein the plurality of candidate matches comprise at least timestamped engagement hashes; receiving the plurality of candidate matches; decrypting at least a portion of the plurality of candidate matches; comparing at least the portion of the timestamped engagement hashes to at least one of the timestamped installation hash and the installation keyed hash; when at least a portion of at least one of the timestamped engagement hashes matches at least a portion of the timestamped installation hash, identifying the timestamped installation hatch as at least one possible valid match; and transmitting, to the server, the at least one possible valid match for validation.

### BRIEF DESCRIPTION OF THE DRAWINGS

FIG. 1 is a block diagram of an example system for on device attribution according to aspects of the disclosure.

FIG. 2 is a flow diagram of an example process for determining attributions according to aspects of the disclosure.

FIG. 3 is a block diagram of an example system according to aspects of the disclosure.

FIG. 4 is a flow diagram of an example method for on device attribution according to aspects of the disclosure.

### DETAILED DESCRIPTION

The technology is generally directed enabling on-device attribution using network identifier-derived transient identifiers. The attribution may be determined based on a user engagement with digital content and subsequent installation of an application associated with the digital content. The digital content may be, for example, text, images, videos, etc. provided for output on a publisher's website or mobile application, or the like. Previously, attributions were determined using personal identifiers associated with the user and/or the device, such as user IDs, usernames, email addresses, cookies, or the like, which provided little to no user privacy. Moreover, determining attributions required that the personal identifiers leave the user device, such that the personal identifiers were able to be determined via an attack.

As discussed above and herein, the use of network identifiers to generate transient identifiers provides the user of the device privacy, by not providing any identifiers associated with the user, e.g., names, email addresses, log-in information, or the like. The use of network identifiers and, more specifically, network identifier-derived transient identifiers, was not previously available because of the computational complexity required by the user device. In particular, user devices in the past did not have the processing power, memory, and/or network communication capabilities to allow for network identifiers to be hashed, encrypted, decrypted, transmitted, and received in a manner that would efficiently and effectively determine attributions. However, as user devices continue to improve with respect to the processing power, memory, and network connection capabilities, the use of network identifiers to determine attributions can happen on the device within milliseconds, which is the direct result of the improvement in the user devices.

Previous iterations of network protocols had devices sharing network identifiers based on the network the devices were connected to. This was typically done because there were not enough unique network identifiers for each device to be attributed, or associated, with their own unique network identifiers. However, as network protocols, such as internet protocols, advance, devices can be attributed or associated with a network identifier. This allows for the network identifier associated with a device to substantially remain consistent between user engagement with digital content and installation of an application. By having the network identifier remain constant, the systems described herein can determine whether to attribute the attribution to the device, while keeping identifiable information contained to the device. While the advancements in network protocols result in more accurate attribution determinations, the systems described herein can still determine attributions for devices and networks using previous iterations of network protocols.

Further, as personal information never leaves the device, any attributions that are determined on the user device are transmitted to servers after being masked or obscured. By determining attributions on the device using network identifiers, the privacy of the users is preserved while complying with attribution transparency regulations.

To determine the attribution, the system uses network identifiers, such as internet protocol (IP) addresses, of the device associated with user engagement and application installation. For example, a platform may include one or more servers such as a digital content server, an engagement server, and a privacy server. The digital content server may receive a request from a publisher, e.g., a website or mobile application, to provide digital content. The digital content may be, in some examples, an advertisement. For example, the advertisement may be for an application available for download. The application may be associated with the publisher and/or content creator of the digital content.

The digital content may be provided for output on a display of a device, such as a user device. The digital content may be interactive, such that the system is configured to receive a user input, e.g., user engagement, in connection with the digital content. A network identifier of the device that received the user engagement with the digital content may be determined. For example, user engagement may include a user input corresponding to the selection of the digital content.

An indication of the user engagement with the digital component may be transmitted to the platform. The indication may include, for example, the network identifier of the device associated with the user engagement, a timestamp associated with the user engagement, and/or an application identifier. The timestamp may include the date and/or time of the user engagement with the digital content. The timestamp may be rounded down or up based on a predetermined conversion window set by the privacy server. The engagement server may be configured to generate a keyed hash based on the network identifier associated with the user engagement (hereinafter referred to as the “engagement keyed hash” for purposes of ease and clarity). In some examples, the engagement server may be configured to generate a hash based on the engagement keyed hash and the timestamp associated with the user engagement and/or the application identifier (hereinafter referred to as the “timestamped engagement hash” for purposes of ease and clarity).

The engagement keyed hash and the timestamped engagement hash may be stored by the privacy server in a database to be queried at a later time. For example, the database may be queried to determine attributions after an application is installed on a user device. The query may be, in some examples, to determine whether a user engagement with digital content resulted in the installation of an application associated with the digital content.

According to some examples, in response to the user engagement with the digital component, an application server may provide for output on the display of the device an application available for installation on the user device. The user device may receive an input corresponding to a selection to install the application associated with the digital content. A network identifier of the device associated with the installation of the application associated with the digital content may be determined. The device may be configured to generate a keyed hash based on the network identifier of the device associated with the installation (hereinafter referred to as the “installation keyed hash” for purposes of ease and clarity). In some examples, the device may be configured to generate a hash based on the installation keyed hash and the timestamp associated with the application and/or the application identifier (hereinafter referred to as the “timestamped installation hash” for purposes of ease and clarity).

The device may transmit an indication of the installation to the platform. For example, the indication may be a query to determine whether to attribute the installation to a user engagement with digital content. The query may include, for example, a portion of the installation keyed hash. The platform and, in some examples, the privacy server may receive the query and identify candidate matches. For example, the privacy server may query the database to identify candidate matches, e.g., engagement keyed hashes, in which at least a portion of the engagement hashes corresponds to the at least a portion of the installation keyed hash.

The privacy server cannot identify an exact match as the privacy server receives, as part of the query, at least a portion of the installation keyed hash. According to some examples, the installation keyed hash, that is generated as a keyed hash of the network identifier, may be hashed using a given protocol. The protocol may be, for example, SHA256. The privacy server may query the database to identify entries, e.g., candidate matches in which the portion of the installation keyed hash corresponds to a portion of the entry. The entries in the database, e.g., the engagement keyed hashes and/or the timestamped engagement hashes, may have been hashed using the same protocol as the device. By having the device and the platform use the same hash protocol, the hashes generated by the device and the platform can be compared.

The privacy server may identify candidate matches based on the portion of the installation keyed hash. The candidate matches may be database entries in which at least a portion of the hash in the entry corresponds to the portion of the installation keyed hash in the query received from the device. The privacy server may be configured to compare the installation keyed hashes to the hashes in the database as at the platform and the device used the same hash function. By using the same hash function, and presuming that the network identifier of the device is the same for the user engagement and the application installation, the portion of the installation keyed hash would match one or more database entries. The matches identified by the privacy server may be identified as candidate matches. The privacy server may encrypt the candidate matches before transmitting the candidate matches to the device in response to the query.

The device may determine whether to attribute the installation to a given user engagement with the digital content based on the candidate matches. For example, the device may decrypt the candidate matches. The device may compare the timestamped engagement hashes to the installation keyed hash to determine whether there is a match. In examples where at least a portion of the timestamped engagement hash matches the installation keyed hash, the device may attribute the installation to the user engagement with the digital content. An indication of the match and, therefore, the attribution, may be transmitted to the platform, e.g., to the privacy server. The validation engine of the privacy server may log the attribution and provide information associated with the attribution to the publisher, content creator, or the like. For example, the validation engine may determine to attribute a user engagement with digital content with a subsequent installation of an application based on matching, or corresponding, timestamped installation hashes and timestamped engagement hashes. In examples where the timestamped installation hashes and timestamped engagement hashes correspond to one another, and the associated timestamps are within an attribution window, the validation engine may attribute the user engagement with digital content with a subsequent installation of an application. The timestamps may be an aggregate duration, in the order of hours, days, weeks, etc.

The hashes, e.g., hash functions, described above and herein may be a hash function from strings to elliptic curve points, a hash function from strings to strings, or the like. The hash functions may, in some examples, be any hash function that would allow the methods described herein to function. The hash functions, for the methods described above and herein, are consistent throughout the method, e.g., the same hash function is used on the user device as well as the platform. According to some examples, the hashes described above and herein may be a hash of the entire network identifier, a portion of the network identifier, or a combination of both.

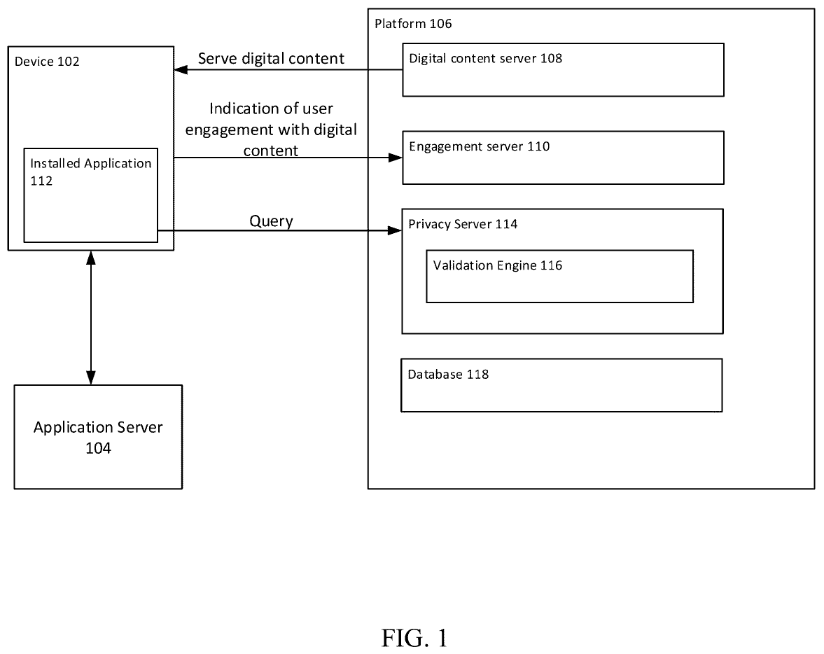

FIG. 1 is an example block diagram of a system according to aspects of the disclosure. The system may include a device 102, an application server 104, and a platform 106.

The device 102 may be, for example, a personal computing device, such as a smartphone, tablet, smart hub, smart glasses, smart helmet, laptop, desktop computer, or the like. In some examples, the device 102 may be a device that is part of a network, such as a server, a virtual machine, or the like. The device 102 may be capable of receiving user inputs via a touch screen, keyboard, mouse, etc. The device 102 may include a display, such as an integrated or remote display, capable of providing a visual output of content.

The device 102 may be configured to output content provided by a publisher, such as content of a webpage, application, mobile application, or the like. The publisher of the content may transmit a request to a digital content server 108 to provide digital content for output on the webpage, etc. The digital content may be, for example, text, images, or videos. In some examples, the digital content may be an advertisement associated with the content of the webpage, etc. In yet another example, the digital content may be for an advertisement of an application associated with the content of the webpage, the publisher of the webpage, or the like.

The device 102 may receive one or more user inputs associated with the digital content. The one or more user inputs associated with the digital content may be, for example, user engagements with the digital content. In some examples, the user engagement may be a click. In yet another example, the user engagement may be that the digital content has been viewed or provided for display for a predetermined period of time. The device 102 may transmit an indication of the user engagement to the platform 106.

The indication of the user engagement may include, for example, a network identifier of the device 102, a timestamp associated with the user engagement, and/or an application identifier associated with the digital content. The platform 106 and, in some examples, the engagement server 110, may receive the indication of the user engagement and generate a keyed hash, e.g., an engagement keyed hash. The engagement keyed hash may be a hash generated using the network identifier associated with the user engagement. The engagement server 110 may be configured to generate a hash of the engagement keyed hash and the timestamp associated with the user engagement, and/or an application identifier associated with the digital content, e.g., the timestamped engagement hash. The timestamp may be, for example, a date and/or time associated with the user engagement. The timestamp may be an aggregate duration, such as a time within a given number of hours, days, weeks, etc. According to some examples, rather than generating the timestamped engagement hash with the timestamp, the timestamped engagement hash may be generated using a bucketed date. The bucketed date may correspond to an attribution window, or window of time for determining whether an application installation can be attributed to a user engagement. By using the engagement keyed hash when generating the timestamped engagement hash, the network identifier is obfuscated before the timestamped engagement hash is generated. The timestamped engagement hash may be, for example, a transient identifier associated with the user engagement. The engagement keyed hash and the timestamped engagement hash may be stored in database 118 for querying to determine attributions associated with the user engagement.

According to some examples, the timestamped engagement hash may be generated for different attribution windows. The attribution windows may correspond to a period of time in which an installation of an application could, or would, be attributed to the user engagement. In some examples, the attribution window may be a period of time corresponding to days inclusive of the day of the user engagement, the current week, days in the future, week in the future, etc. In some examples, the user engagement may be logged twice, e.g., multiple timestamped engagement hashes may be generated for a given user engagement based on the attribution window. When stored in the database 118, the timestamped engagement hashes may be bucketed, or grouped, based on the attribution window. In such an example, all user engagements that occur within the attribution window, e.g., a given day or week, may be within the same bucket.

In some examples, the engagement server 110 may generate an attribution parameter and a deidentification parameter associated with the user engagement. The attribution parameter may be used to measure, quantify, determine, etc. attributions associated with digital content provided for output. The attribution parameter can be used to determine attributions based on user engagement with the digital content, thereby allowing publishers and/or content creators to optimize the performance of a digital content campaign. The deidentification parameter may be generated based on the timestamp associated with the user engagement and/or the application identifier. In some examples, the deidentification parameter corresponds to a hash of an event identifier. The event identifier includes a timestamp, server identifier, and process identifier. According to some examples, an engagement identifier may include the attribution and/or deidentification parameters.

The engagement server may 110 may generate a hash of the deidentification parameter and the engagement identifier. The hash of the deidentification parameter and engagement parameter associated with a user engagement may be stored, for example, in the database 118 along with the engagement keyed hash, timestamped engagement hash, and/or any raw identifiers.

The privacy server 114 may receive the engagement keyed hash, the timestamped engagement hash, and the attribution parameter and deidentification parameter to be stored in database 118. In some examples, the privacy server 114 may receive a raw, e.g., un-hashed or unencrypted, user engagement identifier. The user engagement identifier may be an identifier associated with the user engagement with the digital content. For example, if the user engagement with the digital content is a click or selection of the digital content, the user engagement identifier may correspond to a click or selection identifier.

According to some examples, in response to the user engagement with the digital content, an application server 104 may provide for output one or more applications available for installation on device 102. The applications may be associated, or related to, the digital content, the publisher of the digital content, the content creator of the digital content, or the like. The device 102 may receive one or more user inputs to install at least one application from the application server 104. In response to the user inputs, the application may be installed on the device 102, e.g., installed application 112. In other examples, the device 102 sends an independent request to the application server 104 for installing an application. The application 112 can include a module that allows for on device attribution determinations.

The device 102 executing the installed application 112 may, in response to the application being installed, fetch, from the platform 106, the on-device attribution configuration. The attribution configuration may include, for example, the network address of the user device, an “L-bit” value, and an attribution window. The network address is obfuscated, or masked, via a keyed hash to prevent any attacks from being able to determine the network address.

The device 102 executing the installed application 112 may generate the installation keyed hash based on the network identifier of the device 102. The device 102 executing the installed application 112 may generate a timestamped installation hash by hashing the installation keyed hash and the timestamp associated with the installation, and/or an application identifier. The timestamp may be, for example, a date and/or time associated with the installation. The timestamp may be an aggregate duration, such as a time within a given number of hours, days, weeks, etc. The timestamped installation hash may be encrypted using a device side key.

In some examples, the device 102 may transmit, to platform 106, an indication of installation. The indication may, in some examples, be a query such that the device 102 can determine whether the installation can be attributed to a user engagement with digital content. The indication, or query, includes at least a portion of the installation keyed hash. By including at least a portion of the installation keyed hash, rather than the entirety of the installation keyed hash and/or the raw data (e.g., the network identifier), the platform 106 cannot determine or identify an exact match. This prevents the platform 106 from detecting any identifiable information about the user, user device 102, etc. In some examples, the indication may be transmitted to privacy server 114. For example, the device 102 may transmit to the platform 106 a “L-bit” portion, or prefix, of the installation keyed hash. “L” may be a number of bits that is small enough such that the platform 106 is able to identify candidate matches, while maintaining anonymity, while also large enough such that the platform 106 does not identify and/or return too many matches, thereby keeping network usage low. For example, “L” may be a number of bits that is large enough to allow for the portion of the installation keyed hash to be matched to another hash but also small enough to allow the installation keyed hash to maintain anonymity. The larger the value of “L”, the fewer candidate matches the server may identify as compared to a smaller value of “L.” A smaller “L” value would result in a larger list of candidate matches, as a larger “L” value provides more information to the platform 106 regarding the transient identifier, e.g., the installation keyed hash. However, the larger the “L” value, the anonymity associated with the transient identifier is decreased.

The device 102 may, additionally, transmit the timestamped installation hash. In such an example, the timestamped installation hash may be encrypted using a device side generated key prior to the transmission. For example, device 102 may generate a random key “R” and use the random key “R” to encrypt the timestamped installation hash.

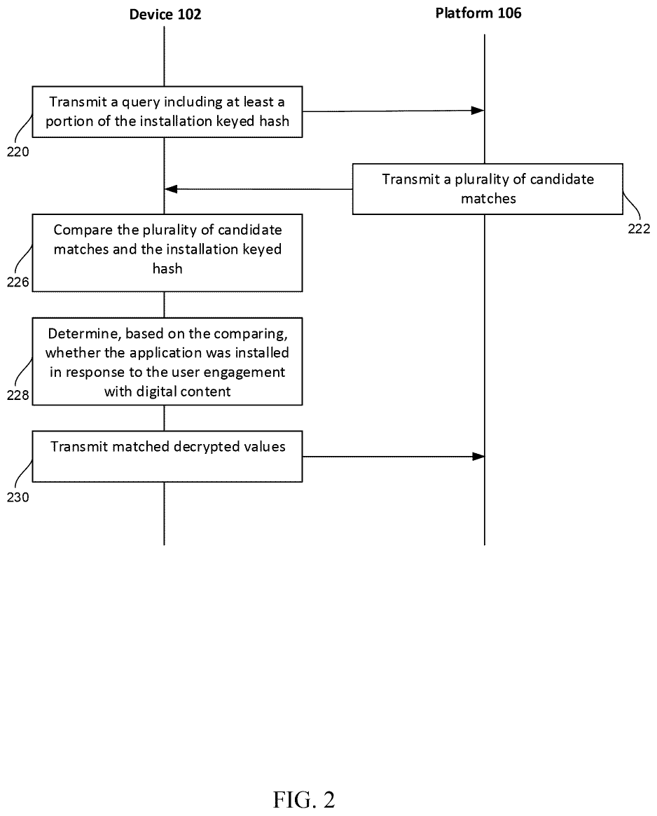

FIG. 2 is an example flow chart illustrating an example method of determining whether to attribute an installation of an application to a user engagement with the digital content.

In block 220, the device 102 executing the installed application 112 may transmit a query to the platform 106 such that the device 102 can determine whether the installation can be attributed to a user engagement with digital content. The query may include a portion of the installation keyed hash. In some examples, the query may be transmitted to privacy server 114. For example, the device 102 may transmit to the platform 106 a “L-bit” portion, or prefix, of the installation keyed hash. “L” may be a number of bits that is small enough to allow for the portion of the installation keyed hash to be matched to another hash, e.g., an engagement keyed hash, but also large enough to allow the installation keyed hash to maintain anonymity. The device 102 may, additionally, transmit, as part of the query, the timestamped installation hash. In such an example, the timestamped installation hash may be encrypted using a device side generated key prior to the transmission. For example, device 102 may generate a random key “R” and use the random key “R” to encrypt the timestamped installation hash. The platform 106 can use the random key “R” to encrypt the timestamped engagement hashes.

The platform 106 may receive the query. In some examples, the privacy server 114 may receive the query. The platform 106 may identify database 118 entries in which a portion of the engagement keyed hash matches, or corresponds to, the portion of the installation keyed hash and/or the encrypted timestamped installation hash in the query. For example, the engagement server 110 uses a given hash function to generate the engagement keyed hash and the timestamped engagement hash. The device 102 uses the same hash function to generate the installation keyed hash and the timestamped installation hash. If the network identifier of the device is the same for the user engagement as at the time of the application installation, at least a portion one or more entries in database 118 will correspond to the portion of the installation keyed hash.

According to some examples, platform 106 may filter the database 118 based on the attribution window, another window of time, the timestamp, application identifier, or the like. For example, the platform 106 may filter the database 118 to remove user engagement with a timestamp that occurred after the timestamp of the installation of the installed application 112. The window of time may be, for example, an amount of time corresponding to the day of the installation, hours or minutes before the installation, etc. According to some examples, the candidate matches may be filtered based on the publisher or creator of the application to ensure that the timestamped engagement hashes and timestamped installation hashes are relevant and remain siloed. Filtering out user engagements and, therefore timestamped engagement hashes, with a timestamp that occurred after the installation of installed application 112 removes erroneous user engagements with the digital content that could not have led to the installation of installed application 112. Further, by filtering the database 118 when identifying candidate matches, computational efficiency is increased as the platform 106 only has to compare relevant, remaining entries with the hash(es) within the query. Accordingly, the platform 106, after filtering the entries, has fewer comparisons to make thereby increasing computational efficiency and decreasing processing power.

In some examples, if there are less than a threshold number of candidate matches, the device 102 may determine that there is no match and, therefore, no attribution.

In examples where, after filtering, there are at least the threshold number of candidate matches, the platform 106 may hash, or encrypt the timestamped installation hash that was received as part of the query from the device 102 to generate a doubly encrypted timestamped installation hash. For example, the timestamped installation hash is initially encrypted using a client key, e.g., random key “R.” The timestamped installation hash is then encrypted using a server, or platform 106, key to to generate the doubly encrypted timestamped installation hash. The timestamped installation hash may be encrypted. In some examples, the timestamped installation hash is encrypted using a commutative property. The use of the commutative property during encryption may be referred to as a commutative encryption.

In some examples the platform 106 may generate an encryption of the attribution parameters and deidentification parameters associated with the candidate matches. The encryption of the attribution parameters and the deidentification parameters may be done using an unauthenticated encryption.

In a normal encryption, when the hash or string (e.g., the encrypted timestamped installation hash) is decrypted, the device 102 would know or receive an indication that the decryption has succeeded or not. In contrast, if the encryption (e.g., the encryption of the attribution parameters and the deidentification parameters) is unauthenticated, the device 102 would not know or receive an indication as to whether the decryption has succeeded or not. The use of normal and unauthenticated encryption prevents devices 102 from determining, or identifying, whether there is a valid match from the candidate matches. For example, the combination of the two encryptions may hide both successful and unsuccessful encryption results from the device 102 at the time of the query. The encryptions may be transmitted to the device 102 as part of the plurality of candidate matches. The encrypted timestamped engagement hashes may be represented as a transient identifier of the matched interactions.

The candidate matches transmitted by the platform 106 to the device 102 includes encrypted timestamped installation hashes (e.g., the doubly encrypted installation hash) and/or a list of timestamped engagement hashes. The timestamped engagement hashes may be hashes in which at least a portion of the timestamped engagement hash corresponds to the portion of the installation keyed hash transmitted by the device 102 as part of the query. The timestamped engagement hashes transmitted by the platform 106 to the device 102 may be redacted such that only a portion of the timestamped engagement hashes are visible, or accessible, by the device 102.

In block 222, the platform, e.g., the privacy server 114, transmits the candidate matches to the device 102. The candidate matches include encrypted timestamped installation hashes. The encrypted timestamped installation hash that is transmitted to the device 102 as part of the candidate matches may be redacted. The device 102 decrypts the encrypted timestamped installation hashes using the device side generated key, “R.” For example, the device 102 decrypts the encrypted timestamped installation hashes returned by platform 106 with its own key, e.g., device side key, “R.”

The device 102 may, in some examples, redact the result of the decryption, e.g., the timestamped engagement hash which is encrypted by the server, or platform 106, side key. The device 102 redacts the result of the decryption using the same redaction protocol the platform 106 used to redact the timestamped engagement hashes. For example, once decrypted by the device 102, the device 102 redacts the timestamped installation hash such that only a portion of the timestamped installation hash may be visible, or accessible, by the device 102 as the timestamped installation hash may be redacted. The redaction of a portion of the timestamped installation hash may prevent the system and, more specifically, the device 102, from learning whether there is a match between the timestamped engagement hash and the timestamped installation hash.

In some examples, rather than redacting the result of the decryption, the device 102 may perform a portion, or prefix, match on the installation keyed hash and/or the timestamped installation hash with the redacted server encrypted hashes. In this example, the device 102 does not have to redact any hashes or the results of a decryption and, instead, compares the portion, or prefix, of the hashes to determine if there is a match.

The privacy server 114 may, additionally, as part of the candidate matches, transmit the hashed user engagement identifier. The candidate matches may, additionally, include the encrypted attribution and deidentification parameters associated with the respective timestamped engagement hashes. The device 102 may decrypt the encrypted attribution and deidentification parameters.

In block 226, the device 102 may compare the redacted hash encryption, e.g., the redacted timestamped installation hashes, with the list of candidate matches received from the platform 106. For example, the device 102 may compare the redacted timestamped installation hash with at least a portion of the timestamped engagement hash. In some examples, the portion of the timestamped engagement hash may be a redacted timestamped engagement hash.

In block 228, the device 102 may determine, based on the comparison in block 226, whether any of the candidate matches are possible valid matches. A valid match is a match indicating that the application was installed in response to the user engagement with the digital content. Possible valid matches occur when there is a match between at least a portion of one of the timestamped engagement matches and at least a portion of the installation keyed hash and/or the timestamped installation hash. The device 102, however, cannot determine whether a match is a valid match. Instead, the device 102 transmits any possible valid matches to platform 106 for validation. In some examples, the platform 106 may transmit at least one candidate match that the device 102 would determine to be a possible valid match. By including at least one candidate match that the device 102 would determine to be a possible valid match, the device 102 is prevented from determining whether or not an attribution actually occurred. For example, by including at least one candidate match that the device 102 would determine to be a possible valid match, the device 102 is prevented from determining that there is no attribution for the installation of an application on the device 102. This further ensures anonymity associated with determining attributions.

For example, the device 102 may receive, in response to the query, doubly encrypted timestamped engagement hashes. The first encryption of the timestamped engagement hash may be done using a server key to generate the timestamped engagement hash while the second encryption of the encrypted timestamped engagement hash may be encrypted using a device key. The device 102 can then decrypt the doubly encrypted timestamped engagement hashes to obtain the singly encrypted timestamped engagement hash, e.g., the timestamped engagement hash encrypted using the server key. Decrypting the doubly encrypted timestamped engagement hashes is possible in view of the commutative encryption used to initially encrypt the hashes. The device 102 may compare the singly encrypted timestamped engagement hash returned by platform 106 for each potential match to determine which, if any, is a possible match. A possible match occurs when at least a portion of the timestamped engagement hash corresponds to at least a portion of the timestamped installation hash and/or installation keyed hash. The device 102 may determine if there are any matches based on the redacted timestamped engagement hashes such that the device 102 can filter out any non-matches. Further, by determining if there are any matches based on redacted timestamped engagement hashes, the device 102 can determine possible valid matches. However, the device 102 may not be able to determine the actual valid match, if any.

The device 102 may, additionally, receive, in response to the query, the unauthenticated encryption of the attribution and deidentification parameters. The device 102 can then decrypt the unauthenticated encryption of the attribution and deidentification parameters. If the decryption was successful, the string would be an encrypted value (hereinafter referred to as an “ondevice encrypted value” for purposes of ease and clarity). The platform 106 has access to the final encryption key such that, if the platform 106 can decrypt this ondevice encrypted value successfully using the encryption key, the possible valid match can be determined to be an actual valid match.

According to some examples, device 102 may deduplicate, or identify any duplicate, candidate matches and/or possible valid matches based on the metadata associated with the timestamped engagement hashes. For example, the device 102 may identify duplicate candidate matches received from the platform 106 in response to the query and/or possible valid matches identified in response to comparing the timestamped engagement and installation hashes. The device 102 may identify duplicate matches based on the timestamp and/or application identifier within the timestamped engagement hash. However, as the candidate matches are redacted, the device 102 cannot identify the actual valid match. Rather, the device 102 dedupes the received candidate matches across multiple potentially matched cohorts to identify the possible valid matches.

The device 102 may cache the matched and encrypted value for attribution logging. For example, the device 102 may attach the matched and encrypted value to an open event for attribution logging.

In block 230, the device 102 may transmit the possible valid matches to the platform 106 for validation and/or conversion. The possible valid matches may be, for example, the decrypted deidentification parameters associated with the timestamped engagement hashes that were transmitted in response to the query. Since the encryption of the deidentification parameters is done via an unauthenticated encryption, the device cannot determine if a possible match is an actual match. To determine an actual match, the device 102 transmits the possible matches to the platform 106, which has the information necessary to determine actual matches.

As an example, the device 102 may have a list of possible valid matches in which the portions of the hashes match, the timestamps are within the attribution window, and the like. To determine which, if any of the possible valid matches can be identified as an attribution, the device 102 may transmit the possible valid matches to the platform 106 to determine which, if any, are a valid match. For example, each possible valid match may be the result of a decryption of an unauthenticated decryption, e.g., the unauthenticated decryption of the attribution and deidentification parameters, for which, if the decryption was successful, the string would be the ondevice encrypted value. The platform 106 has access to the final encryption key such that, if the platform 106 can decrypt this ondevice encrypted value successfully using the encryption key, the possible valid match can be determined to be an actual valid match.

As an example, platform 106 may attempt to decrypt the ondevice encrypted value transmitted from device 102. If the decryption is successful, the platform 106 may identify the attribution parameter and deidentification parameter associated with the decrypted hash. The attribution parameter and deidentification parameter may be copied and encrypted prior to transmitting an indication of a match to the device 102. In examples where the platform 106 cannot decrypt the values, the platform 106 may encrypt the first identified match with the same key and transmit that encrypted match as the allegedly valid match.

By sending the possible valid matches to the platform 106 for validation by platform 106, this prevents device 102 from determining whether there is a valid match and, therefore, an attribution associated with the user engagement. For example, the candidate matches received by the device 102 are encrypted, or hashed, in a way that the device 102 would not be able to determine whether there was a valid match and, therefore, an attribution. Further, as device 102 may identify multiple possible valid matches in which the portion of the timestamped installation hashes and timestamped engagement hashes correspond to one another, and the associated timestamps are within an attribution window, the device 102 cannot determine which possible match is a valid match. To do so, the device 102 transmits the possible valid matches to the platform 106, which decrypts the possible matches to determine whether the possible match is a valid match.

According to some examples, if the platform 106 determines that there is not a valid match, the platform 106 may identify one of the possible valid matches as the alleged valid match. The platform 106 would encrypt the alleged valid match and transmit the encrypted alleged valid match to the device 102 such that the device 102 would identify the alleged valid match as an actual match. By transmitting an alleged valid match to the device 102, even when there is no actual valid match, the device 102 is unaware as to whether the installation of an application can be attributed to a user engagement with digital content.

In some examples, the device 102 may transmit the event, e.g., the event for attribution logging, to a server that may be part of platform 106, e.g., validation engine 116, or separate from platform 106. The event may be the valid match, whether actual or alleged. The values and/or events received by the platform 106 may include, for example, an indication of the matched timestamped engagement hash, attribution parameters, deidentification parameters, and/or engagement identifiers.

The deidentification parameters may be used by the validation engine 116 to log deidentification parameters associated with an attribution or conversion to an attribution log.

The attribution parameters may be attached, or associated, with existing attribution, or conversion, pings. The validation engine 116 may decrypt the attribution parameters and, if the decryption was successful, the validation engine may log the attribution parameters associated with an attribution or conversion to an attribution log.

The systems and methods described above and herein can be compared to a key-value lookup to the platform 106, while the device 102 hides what the device side keys are through hashes, portions of hashes, and encryptions. The platform 106 also tries to hide the values from the device 102 through authenticated encryptions and key redactions. this allows for the system to ensure that any private or personal identifying information is not shared between the device 102 and the platform 106, thereby complying with attribution transparency regulations.

### Example Systems

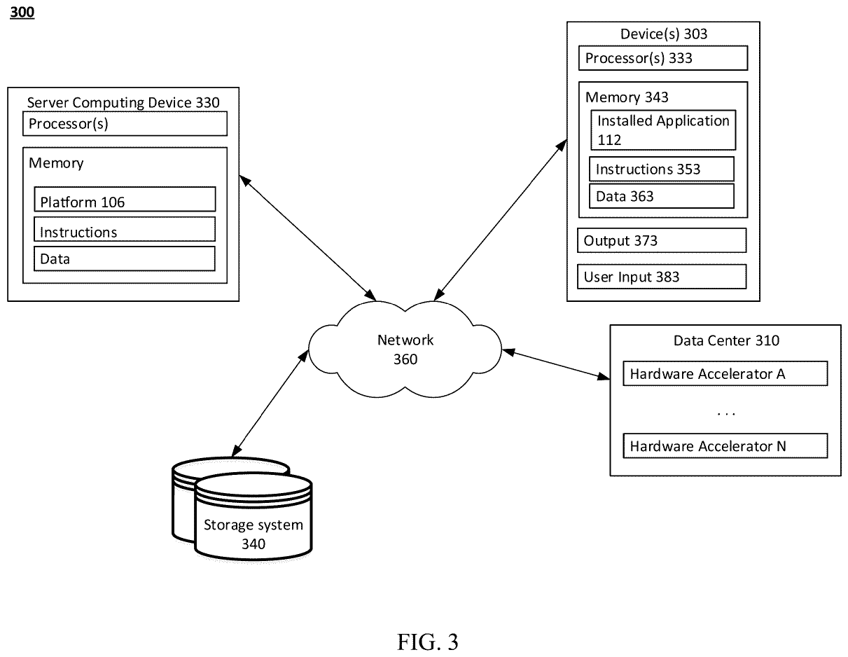

FIG. 3 illustrates an example system 300 in which the features described above may be implemented. It should not be considered limiting the scope of the disclosure or usefulness of the features described herein. In this example, system 300 may include device(s) 303, server computing device 330, storage system 340, and network 360.

Aspects of the disclosure can be implemented in a computing system that includes a back-end component, e.g., as a data server, a middleware component, e.g., an application server, or a front-end component, e.g., user computing device 303 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The system 300 can include clients, e.g., user computing device 303 and servers, e.g., server computing device 330. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Each device 303 may be a personal computing device intended for use by a respective user. The device 303 may include one or more processors 333, memory 343, data 363 and instructions 353. Each device 303 may also include an output 373 and user input 383. By way of example only, devices 303 may be mobile phones or devices such as a wireless-enabled PDA, smartphones, a tablet PC, desktop computing device, a wearable computing device (e.g., a smartwatch, AR/VR headset, smart helmet, etc.), a netbook that is capable of obtaining information via the Internet or other networks, or a smart home device, such as a home assistant, smart thermostat, smart doorbell, smart light, etc.

Memory 343 of device 303 may store information that is accessible by processor 333. Memory 343 may also include data that can be retrieved, manipulated or stored by the processor 333. The memory 343 may be of any non-transitory type capable of storing information accessible by the processor 333, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 343 may store information that is accessible by the processors 333, including instructions 353 that may be executed by processors 333, and data 363. According to some examples, memory 343 may store installed application 112.

Data 363 may be retrieved, stored or modified by processors 333 in accordance with instructions 353. For instance, although the present disclosure is not limited by a particular data structure, the data 363 may be stored in computer registers, in a relational database as a table having a plurality of different fields and records, XML documents, or flat files. The data 363 may also be formatted in a computer-readable format such as, but not limited to, binary values, ASCII or Unicode. By further way of example only, the data 363 may comprise information sufficient to identify the relevant information, such as numbers, descriptive text, proprietary codes, pointers, references to data stored in other memories (including other network locations) or information that is used by a function to calculate the relevant data.

The instructions 353 can be any set of instructions to be executed directly, such as machine code, or indirectly, such as scripts, by the processor 333. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 333 may include any conventional processors, such as a commercially available CPU or microprocessor. Alternatively, the processor can be a dedicated component such as an ASIC or other hardware-based processor. Although not necessary, computing devices 303 may include specialized hardware components to perform specific computing functions faster or more efficiently.

Although FIG. 3 functionally illustrates the processor, memory, and other elements of devices 303 as being within the same respective blocks, components described in this specification, including the processors and the memories can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

Output 373 may be a display, such as a monitor having a screen, a touch-screen, a projector, or a television. The display 373 of the one or more computing devices 303 may electronically display information to a user via a graphical user interface (“GUI”) or other types of user interfaces. For example, as will be discussed below, display 373 may electronically display query results.

The user input 383 may be a mouse, keyboard, touch-screen, microphone, or any other type of input.

The devices 303 can be at various nodes of a network 360 and capable of directly and indirectly communicating with other nodes of network 360. Although one device is depicted in FIG. 3, it should be appreciated that a typical system can include one or more devices, with each device being at a different node of network 360. The network 360 and intervening nodes described herein can be interconnected using various protocols and systems, such that the network can be part of the Internet, World Wide Web, specific intranets, wide area networks, or local networks. The network 360 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 300 may include one or more server computing devices 330 having a plurality of computing devices, e.g., a load balanced server farm, that exchange information with different nodes of a network for the purpose of receiving, processing and transmitting the data to and from other computing devices. For instance, one or more server computing devices 330 may be a web server that is capable of communicating with the one or more client computing devices 303 via the network 360. In addition, server computing device 330 may use network 360 to transmit and present information to a user of one of the other computing devices 303.

Server computing device 330 may include one or more processors, memory, instructions, data, etc. These components operate in the same or similar fashion as those described above with respect to computing device 303.

The server computing device 330 may include platform 106, as described above with respect to FIGS. 1 and 2. In that regard, server computing device 330 may include one or more server computing devices corresponding to digital content server 108, engagement server 110, and privacy server 114. While each of digital content server 108, engagement server 110, and privacy server 114 are shown as part of platform 106 and as separate servers, the digital content server 108, engagement server 110, and privacy server 114 may be part of a single server computing device, separate server computing devices, or a combination thereof.

According to some examples, the server computing device 330 may be connected over the network to a data center 310 housing any number of hardware accelerators. The data center 310 can be one of multiple data centers or other facilities in which various types of computing devices, such as hardware accelerators, are located. Computing resources housed in the data center can be specified for repeated results monitoring, including identifying repeated query results, or the like.

The devices 303, 330 can be capable of direct and indirect communication over the network 360. The devices 303, 330 can set up listening sockets that may accept an initiating connection for sending and receiving information. The network 360 itself can include various configurations and protocols including the Internet, World Wide Web, intranets, virtual private networks, wide area networks, local networks, and private networks using communication protocols proprietary to one or more companies. The network 360 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 360, in addition or alternatively, can also support wired connections between the devices 303, 330, including over various types of Ethernet connection.

The server computing device 330 can be configured to receive queries from the client computing device 303 on computing resources in the data center 310. The queries from the client device may be to determine attributions associated with an application download in response to user engagements with digital content. For example, the environment can be part of a computing platform configured to provide a variety of services to users, through various user interfaces and/or application programming interfaces (APIs) exposing the platform services. The variety of services can include identifying content responsive to the query, determining whether query results are repeated query results, or the like. The client computing device 303 can transmit input data associated with a query. The server computing device 330 can receive the input data and, in response, identify and provide for output query results. The query results may be, for example, identified from database 118, which may be stored within storage system 340.

As an example, storage system 340 may be configured to store a database 118 of user engagements with digital content. The database entries may be generated by platform 106 in response to receiving an indication of user engagement with digital content. The storage system(s) 340 can be a combination of volatile and non-volatile memory and can be at the same or different physical locations than the computing devices 303, 330. For example, the storage system(s) 340 can include any type of non-transitory computer readable medium capable of storing information, such as a hard-drive, solid state drive, tape drive, optical storage, memory card, ROM, RAM, DVD, CD-ROM, write-capable, and read-only memories.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

### Example Methods

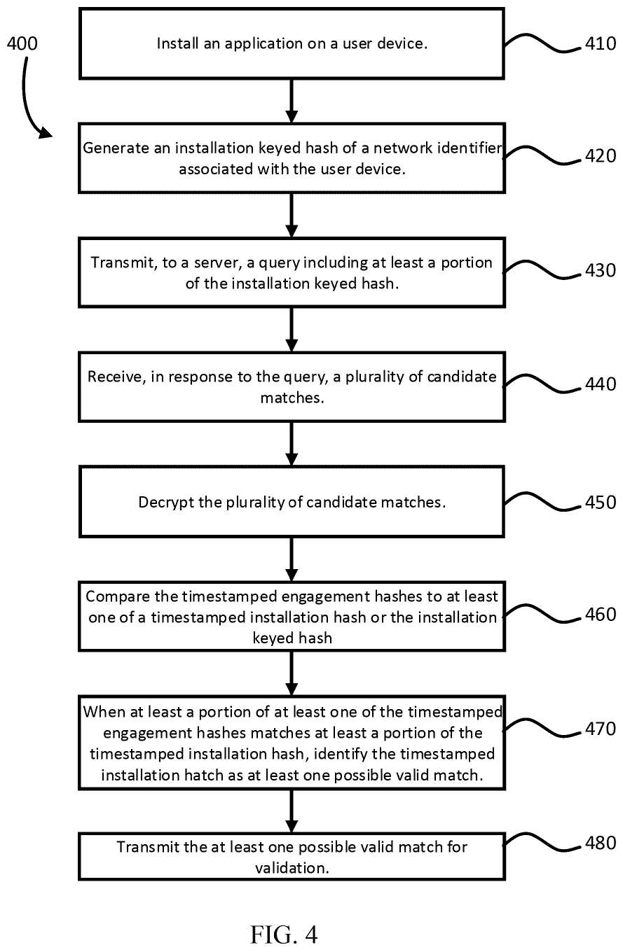

FIG. 4 is a flow diagram 400 for an example method of determining attributions. Determining attributions includes determining whether an application was installed in response to user engagement with digital content. The following operations do not have to be performed in the precise order described below. Rather, various operations can be handled in a different order or simultaneously, and operations may be added or omitted.

In block 410, an application is installed on a user device. The application may be related to a website publisher, digital content creator, subject of the digital content, or the like. For example, the application may be installed in response to a user engagement with digital content. The digital content may be provided for output via a website or mobile application. The website and/or mobile application may be associated with a publisher. The digital content may, in some examples, be created and provided to the publisher by the digital content creator. The digital content creator may be a brand, business, etc. such that the digital content is an advertisement for a product, type of product, service, type of service, etc. In some examples, the application may be installed independent of user engagement with digital content, at a time after the user engagement with the digital content, or the like.

As an example, a publisher may provide for output via the display of the user device the digital content, e.g., via digital content server 108. The device may determine one or more user engagements with the digital content. A user engagement may be, for example, viewing the digital content for a threshold period of time, receiving one or more user inputs corresponding to the selection of the digital content, or the like. In some examples, such as when the digital content is for an application, in response to the user engagement with the digital content, the application may be installed on the user device. The application may include a module for on device attribution determinations. For example, the module may fetch configurations from a server system, such as platform 106. The configurations may include, for example, a value for the L-bit, an attribution window, or the like. In some examples, the module fetches the device network identifier.

According to some examples, an indication of the user engagement with the digital content may be transmitted to a server system, such as platform 106. The platform 106 may receive the indication of the user engagement and generate an encrypted hash, e.g., an engagement keyed hash, based on the network identifier associated with the device that received the user engagement. In some examples, the engagement server 110 of platform 106 may generate the engagement keyed hash. The platform 106 may, additionally, generate a hash of the engagement keyed hash and a timestamp associated with the indication of the user engagement. The resulting hash may be, for example, a timestamped engagement hash. The timestamp may include the date and/or time of the user engagement with the digital content. In some examples, the timestamp may be a window of time, such as a day or week the user engagement occurred. According to some examples, the engagement keyed hash and the timestamped engagement hash may be stored in a database of user engagements.

In block 420, an installation keyed hash may be generated by the user device. The installation keyed hash may be, for example, an encrypted hash of the network identifier associated with the user device the application was installed on. The network identifier may be, for example, an IP address. According to some examples, a hash of the installation keyed hash and a timestamp of the installation may be generated by the user device. The resulting hash may be, for example, a timestamped engagement hash. The timestamp may include the date and/or time the application was installed on the user device. In some examples, the timestamp may be a window of time, such as the day or week the installation occurred. As an example, if the timestamp is a week, any installation that occurred from a given Sunday through a given Saturday (e.g., a given week) may have the same timestamp. In another example, if the timestamp is a day, any installation of that occurred during that day, e.g., whether the installation occurred at 8:00 am or 8:00 pm, the timestamp would be the same day.

In some examples, the network identifier of the device the application was installed on may, in some examples, correspond to or be the same as the network identifier associated with the user engagement. For example, the engagement keyed hash and the timestamped engagement hash is generated using a given hash function. The same hash function is also used to generate the installation keyed hash and the timestamped installation hash. By using the same hash function, if the hashes are generated using the same network identifier, at least a portion of the hashes will correspond to one another.

In block 430, a query including a portion of the installation keyed hash may be transmitted by the user device to a server system, such as platform 106. The portion of the installation keyed hash may, in some examples, be an L-bit prefix of the installation keyed hash. The value of “L” may be any value greater than zero but less than the total number of values in the hash. In some examples, the value of “L” is large enough such that the server system, e.g., platform 106, would identify a plurality of candidate matches to preserve anonymity while also be small enough such that the server system would not identify an abundance of matches, thereby reducing network bandwidth. The query may, additionally, include at least a portion of timestamped installation hash.

In block 440, the device may receive, in response to the query, a plurality of candidate matches. For example, in response to receiving the query from the user device, the server may query the database of user engagements to identify candidate matches. Candidate matches may be matches that occurred within an attribution window, e.g., a window of time. The window of time may be determined based on the timestamp associated with the installation of the application or the timestamp associated with the user engagement with the digital content. For example, the attribution window may correspond to the day, week, month, etc. associated with the timestamp of the installation and/or user engagement.

The plurality of candidates may include, for example, an encrypted timestamped installation hash. For example, the server may encrypt the timestamped installation hash received as part of the query with a serverside key before transmitting the candidate matches to the user device. The timestamped installation hash is an already encrypted hash (e.g., first encrypted using a device side key) such that when the timestamped installation hash is encrypted using a server side key, the result is a doubly encrypted hash.

According to some examples, the plurality of candidate matches may, additionally, include the timestamped engagement hash and/or encrypted values containing the attribution parameter and deidentification parameter associated with the user engagement. The deidentification parameter may be generated based on the timestamp associated with the user engagement and/or the application identifier. The encryption of the attribution parameters and the deidentification parameters may be generated using an unauthenticated decryption, such that, when decrypted, the device would not be able to determine whether the decryption was successful or not.

In block 450, the device may decrypt at least a portion of the plurality of candidate matches. As the candidate matches include an encrypted timestamped installation hash, decryption of the candidate matches results in the timestamped installation hash. In some examples, the result of the decryption is a redacted hash encryption. For example, the encrypted timestamped engagement hash was initially encrypted using a device side key “R.” The timestamped engagement hash was then encrypted using a server side key. The decryption of the encrypted timestamped engagement hash is a redacted hash encryption.

The device may, additionally, decrypt the encrypted attribution and deidentification parameters. The decryption may be results in an encrypted value, e.g., the ondevice encrypted value. However, as the attribution and deidentification parameters were encrypted via unathenticated encryption, the device cannot determine whether the decryption was successful or not.

In block 460, the decrypted plurality of candidate matches, e.g., the redacted timestamped installation hashes, may be compared with the timestamped engagement hashes. The timestamped engagement hashes received as candidate matches may, in some examples, be redacted such that the redacted timestamped installation hashes are compared to redacted timestamped engagement hashes.

In block 470, when at least a portion of the at least one of the timestamped engagement hashes matches at least a portion of the timestamped installation hash or the installation keyed hash, the timestamped installation hash is identified as a possible valid match. In some examples, the ondevice encryption value associated with the timestamped engagement hash may be identified as part of, or as the, possible valid match. As the device cannot determine whether a match is an actual valid match, the device identifies possible valid matches, e.g., a portion of the engagement hashes correspond to a portion of the installation hashes, the timestamps are within the attribution window, etc.

In block 480, the device may transmit the at least one possible valid match to the server system for validation. For example, the device may transmit all matched decrypted values, e.g., timestamped engagement hashes and/or ondevice encryption values, to the server, e.g., platform 106. The platform 106 may, in some examples, validate the matches such that the application installation is attributed to the user engagement. Validation of the possible matches includes, for example, decrypting the timestamped engagement hashes and/or ondevice encryption values. As the timestamped engagement hashes and/or ondevice encryption values were encrypted using a server side key, if the platform 106 can successfully decrypt the possible valid match, the possible valid match is identified as an attribution. In examples where the platform successfully decrypts the possible valid match, the platform 106 identifies the attribution parameter and deidentification parameter associated with the decrypted timestamped engagement hashes and/or ondevice encryption values. The attribution parameter and deidentification parameter may be copied and encrypted prior to transmitting an indication of a match to the device 102. If the platform 106 cannot decrypt any of the possible valid matches, the platform 106 may randomly select a value.

The successfully decrypted value or the randomly selected value is encrypted using a server side key and transmitted to the client as an event, e.g., an event for attribution logging. By transmitting an event, regardless of whether it was a successful decryption or not, the device 102 is prevented from determining if there is an actual valid match.

The device 102 may transmit the event to another server, which may be part of platform 106 or separate from platform 106. For example, the event may be transmitted to validation engine 116 or another server. The event includes indication of the matched timestamped engagement hash, attribution parameters, and/or deidentification parameters. The validation engine 116 logs the deidentification parameters with the associated attribution to an attribution log. The attribution parameters are attached, or associated with, existing attributions, pings, etc. In some examples, the attribution parameters are decrypted and, if successfully decrypted, the validation engine 116 logs the attributions parameters and associated attribution to the attribution log.

While the example methods described above are directed to determining attributions on a user device, different steps of the methods may be performed on the user device and/or the server such that the server may determine attributions, rather than the user device.

While the example methods described herein refer to timestamped installation hashes and timestamped engagement hashes, these hashes may be generated based on a timestamp and/or an application identifier in conjunction with the respective installation keyed hash and engagement keyed hashes. In examples where the installation keyed hash is hashed with the application identifier, the resulting hash may be an identifier installation hash. In examples where the engagement keyed hash is hashed with the application identifier, the resulting hash may be an identifier engagement hash. The device 102 and platform 106 can use the identifier installation hashes and identifier engagement hashes substantially similar to the timestamped installation hashes and the timestamped engagement hashes.

The attributions determined using the systems and methods described above may be used to train one or more artificial intelligence (AI) models, such as machine learning (ML) models, for optimizing digital content campaigns. For example, digital content server 108 may employ one or more AI models to determine relevant digital content, optimize attributions for digital content that is served to user devices, or the like.

Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for determining an application was installed in response to user engagement with digital content, the method comprising:
installing, by one or more processors of a user device, the application on the user device;
generating, by the one or more processors of the user device, an installation keyed hash of a network identifier associated with the user device;
transmitting, by the one or more processors of the user device, to a server, a query including at least a portion of the installation keyed hash;
receiving, by the one of more processors of the user device in response to the query, a plurality of candidate matches;
decrypting, by the one or more processors of the user device, at least a portion of the plurality of candidate matches, wherein the plurality of candidate matches comprise at least a portion of timestamped engagement hashes;
comparing, by the one or more processors of the user device, at least the portion of the timestamped engagement hashes to at least one of a timestamped installation hash or the installation keyed hash;
when at least a portion of at least one of the timestamped engagement hashes matches at least a portion of the timestamped installation hash, identifying, by the one or more processors of the user device, the timestamped installation hash as at least one possible valid match; and
transmitting, by the one or more processors of the user device to the server, the at least one possible valid match for validation.

2. The method of claim 1, wherein the installation keyed hash, the timestamped engagement hashes, and the timestamped installation hash are generated using the same hash function.

3. The method of claim 1, wherein the installation keyed hash and at least one of the timestamped engagement hashes are generated using a same network identifier.

4. The method of claim 1, further comprising transmitting, by the one or more processors of the user device to the server, an indication of the user engagement with the digital content.

5. The method of claim 4, further comprising generating, by one or more processors of the server, a database of user engagements, the generating comprising:
generating, by the one or more processors of the server, an engagement keyed hash of a network identifier associated with the indication of the user engagement, wherein the network identifier associated with the indication of user engagement corresponds to the network identifier associated with the user device;
generating, by the one or more processors of the server, the timestamped engagement hash, wherein the timestamped engagement hash comprises a hash of the engagement keyed hash and a timestamp associated with the indication of the user engagement; and
storing, by the one or more processors of the server in communication with memory, the engagement keyed hash and the timestamped engagement hash.

6. The method of claim 5, wherein the timestamp associated with the indication of the user engagement includes at least one of a date, a time, or a window of time of the user engagement.

7. The method of claim 1, further comprising:
generating, by the one or more processors of the user device, a timestamped installation hash, wherein the timestamped installation hash comprises a hash of the installation keyed hash and a timestamp associated with the application installation.

8. The method of claim 7, wherein the timestamp associated with the application installation includes at least one of a date, a time, or a window of time of the application installation.

9. The method of claim 7, further comprising:
encrypting, by the one or more processors of the user device, the timestamped installation hash using a device side generated key; and
transmitting, by the one or more processors of the user device to the server as part of the query, the encrypted timestamped installation hash.

10. The method of claim 9, further comprising:
encrypting, by the one or more processors of the server, the timestamped installation hash with a server side key such that the timestamped installation hash is doubly encrypted; and
receiving, by the one or more processors of the user device, the encrypted timestamped installation hash as part of the plurality of candidate matches.

11. The method of claim 10, further comprising:
decrypting, by the one or more processors of the user device, the encrypted timestamped installation hash to generate a redacted timestamped installation hash; and
the comparing further comprising comparing, by the one or more processors of the user device, the redacted timestamped installation hash to at least a portion of the timestamped engagement hash.

12. The method of claim 1, further comprising:
filtering, by the one or more processors of the server, the plurality of candidate matches based on a window of time; and
wherein the window of time is determined based on a timestamp associated with an indication that the application has been installed or a timestamp associated with a user engagement with the digital content.

13. The method of claim 1, wherein the plurality of candidate matches comprise a portion of a timestamped engagement hash corresponding to the portion of the installation keyed hash.

14. The method of claim 1, further comprising validating, by the one or more processors of the server, the at least one possible valid match as a valid match, wherein a valid match indicates that the application was installed in response to the user engagement with the digital content.

15. The method of claim 1, further comprising:
decrypting, by the one or more processors of the server, the at least one possible valid match, and
wherein when the at least one possible valid match is successfully decrypted, identifying the at least one possible valid match as an attribution that the application was installed in response to the user engagement with the digital content.

16. The method of claim 1, wherein:
the query further comprises the timestamped installation hash, and
the plurality of candidate matches further comprise at least one of an encryption of the timestamped installation hash or an encryption of attribution and deidentification parameters.

17. (canceled)

18. One or more non-transitory computer-readable media for storing instructions that, when executed by one or more processors, cause the one or more processors to perform operations comprising:
installing, by one or more processors of a user device, the application on the user device;
generating, by the one or more processors of the user device, an installation keyed hash of a network identifier associated with the user device;
transmitting, by the one or more processors of the user device, to a server, a query including at least a portion of the installation keyed hash;
receiving, by the one of more processors of the user device in response to the query, a plurality of candidate matches;
decrypting, by the one or more processors of the user device, at least a portion of the plurality of candidate matches, wherein the plurality of candidate matches comprise at least a portion of timestamped engagement hashes;
comparing, by the one or more processors of the user device, at least the portion of the timestamped engagement hashes to at least one of a timestamped installation hash or the installation keyed hash;
when at least a portion of at least one of the timestamped engagement hashes matches at least a portion of the timestamped installation hash, identifying, by the one or more processors of the user device, the timestamped installation hash as at least one possible valid match; and
transmitting, by the one or more processors of the user device to the server, the at least one possible valid match for validation.

19. (canceled)

20. A system for determining an application was installed in response to user engagement with digital content, the system comprising:
a user device comprising one or more processors, the one or more processors of the user device configured to:
generate an installation keyed hash of a network identifier associated with the user device; and
transmit, to a server, a query including at least a portion of the installation keyed hash;
the server comprising one or more processors, the one or more processors of the server configured to:
identify, in response to the query, a plurality of candidate matches; and
transmit, to the user device, the plurality of candidate matches, wherein the plurality of candidate matches comprise at least timestamped engagement hashes, and
wherein the one or more processors of the user device are further configured to:
receive the plurality of candidate matches;
decrypt at least a portion of the plurality of candidate matches;
compare at least the portion of the timestamped engagement hashes to at least one of a timestamped installation hash and the installation keyed hash;
when at least a portion of at least one of the timestamped engagement hashes matches at least a portion of the timestamped installation hash, identifying the timestamped installation hatch as at least one possible valid match; and
transmit, to the server, the at least one possible valid match for validation.

21. The system of claim 20, wherein the installation keyed hash, the timestamped engagement hashes, and the timestamped installation hash are generated using the same hash function.

22. The system of claim 20, wherein the installation keyed hash and at least one of the timestamped engagement hashes are generated using a same network identifier.

23. The system of claim 20, wherein the one or more processors of the user device are further configured to transmit, to the server, an indication of the user engagement with the digital content.

24. The system of claim 20, wherein the one or more processors of the server are further configured to:
generate a database of user engagements, the generating comprising:
generate an engagement keyed hash of a network identifier associated with the indication of a given user engagement, wherein the network identifier associated with the indication of user engagement corresponds to the network identifier associated with the user device;
generate the timestamped engagement hash, wherein the timestamped engagement hash comprises a hash of the engagement keyed hash and a timestamp associated with the indication of the user engagement; and
store the engagement keyed hash and the timestamped engagement hash.

25. The system of claim 24, wherein the one or more processors of the server are further configured to query the database of user engagements in response to receiving the query from the user device.

26. The system of claim 24, wherein the timestamp associated with the indication of the user engagement includes at least one of a date, a time, or a window of time of the user engagement.

27. The system of claim 20, wherein the one or more processors of the user device are further configured to generate a timestamped installation hash, wherein the timestamped installation hash comprises a hash of the installation keyed hash and a timestamp associated with the application installation.

28. The system of claim 27, wherein the timestamp associated with the application installation includes at least one of a date, a time, or a window of time of the application installation.

29. The system of claim 27, wherein the one or more processors of the user device are further configured to:
encrypt the timestamped installation hash using a device side generated key; and
transmit, to the server, the encrypted timestamped installation hash as part of the query.

30. The system of claim 29, wherein the one or more processors of the server are further configured to:
encrypt the timestamped installation hash with a server side key such that the timestamped installation hash is doubly encrypted; and
transmit, to the user device, the encrypted timestamped installation hash as part of the plurality of candidate matches.

31. The system of claim 30, wherein the one or more processors of the user device are further configured to:
decrypt the encrypted timestamped installation hash to generate a redacted timestamped installation hash; and
the comparing further comprising comparing the redacted timestamped installation hash to at least a portion of the timestamped engagement hash.

32. The system of claim 20, wherein the one or more processors of the server are further configured to:
filter the plurality of candidate matches based on a window of time; and
wherein the window of time is determined based on a timestamp associated with an indication that the application has been installed or a timestamp associated with a user engagement with the digital content.

33. The system of claim 20, wherein the plurality of candidate matches comprise a portion of an timestamped engagement hash corresponding to the portion of the installation keyed hash.

34. The system of claim 20, wherein the one or more processors of the server are further configured to validate the at least one possible valid match as a valid match, wherein a valid match indicates that the application was installed in response to the user engagement with the digital content.

35. The system of claim 34, wherein the one or more processors of the server are further configured to:
decrypt the at least one possible valid match; and
when the at least one possible valid match is successfully decrypted, identifying the at least one possible valid match as an attribution that the application was installed in response to the user engagement with the digital content.

36. The system of claim 20, wherein:
the query further comprises the timestamped installation hash, and
the plurality of candidate matches further comprise at least one of an encryption of the timestamped installation hash or an encryption of attribution and deidentification parameters.

37. (canceled)

38. (canceled)
